(19) United States
(12) Patent Application Publication
(10) Pub. No.: US 2023/0351756 A1
(43) Pub. Date: Nov. 2, 2023

(54) METHOD FOR MASKING AND DISTRIBUTING IMAGES OF INVENTORY STRUCTURES WITHIN A STORE

(71) Applicant: Simbe Robotics, Inc., South San Francisco, CA (US)

(72) Inventors: Dave Cortese, South San Francisco, CA (US); Brad Bogolea, South San Francisco, CA (US)

(21) Appl. No.: 18/083,288

(22) Filed: Dec. 16, 2022

Related U.S. Application Data
(60) Provisional application No. 63/290,591, filed on Dec. 16, 2021.

(51) Int. Cl. G06V 20/50; G06Q 10/087; H04N 7/18; H04N 5/265; G06V 20/70; G06V 10/22; G06V 10/44; G06V 10/26; G06V 10/762

(52) U.S. Cl. CPC G06V 20/50; G06Q 10/087; H04N 7/183; H04N 5/265; G06V 20/70; G06V 10/225; G06V 10/44; G06V 10/267; G06V 10/762; G05D 1/0231

(57) ABSTRACT

A method includes: accessing a query from a first supplier of product to a store; accessing a first image of an inventory structure captured by an optical sensor, deployed in a store, at a first time; identifying a first cluster of regions, in the first image, depicting a first set of slots assigned to product types supplied by the first supplier; identifying a second cluster of regions, in the first image, depicting a second set of slots assigned to product types supplied by a second set of suppliers excluding the first supplier; obfuscating the second cluster of regions in the first image to generate a masked image; and, based on the query, serving the masked image to the first supplier.

### CROSS-REFERENCE TO RELATED APPLICATIONS

This application claims the benefit of U.S. Provisional Application No. 63/290,591, filed on 16 Dec. 2021, which is incorporated in its entirety by this reference.

This application is related to U.S. patent application Ser. No. 16/817,972, filed on 13 Mar. 2020, and Ser. No. 15/600,527, filed on 19 May 2017, each of which is incorporated in its entirety by this reference.

### TECHNICAL FIELD

This invention relates generally to the field of stock keeping and more specifically to a new and useful method for masking and distributing images of inventory structures within a store in the field of stock keeping.

### BRIEF DESCRIPTION OF THE FIGURES

FIG. 1 is a flowchart representation of a method;

FIG. 2 is a flowchart representation of one variation the method;

FIG. 3 is a flowchart representation of one variation the method; and

FIG. 4 is a flowchart representation of one variation the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

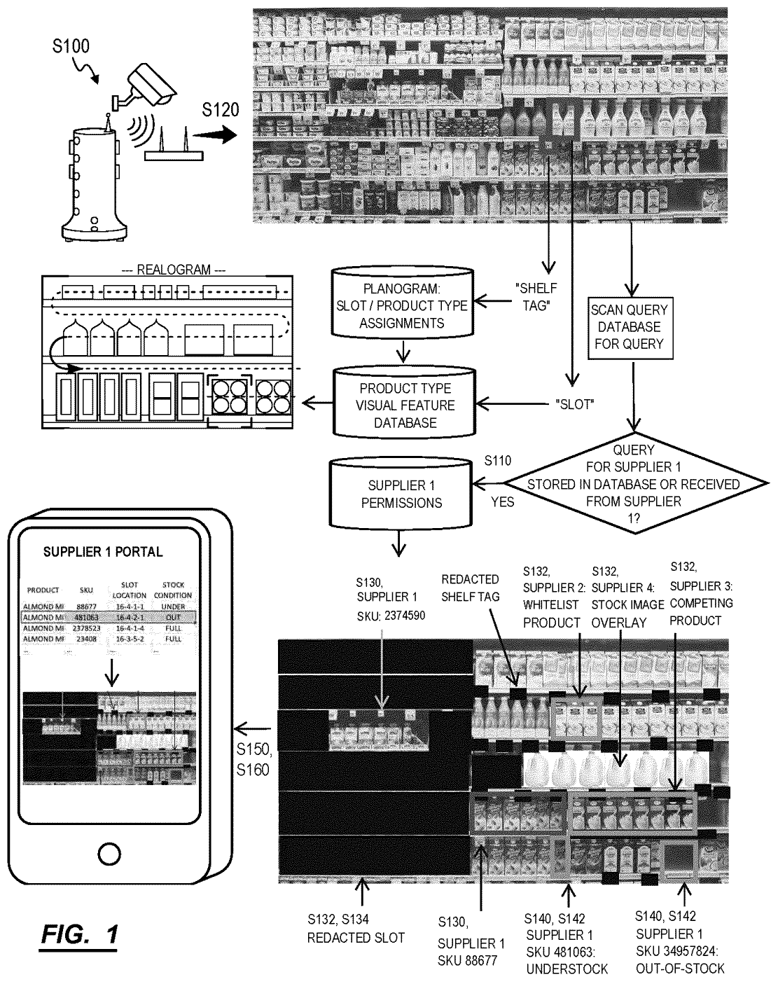

As shown in FIG. 1, a method S100 includes: accessing a query from a first supplier to the store in Block Silo; accessing a first image of an inventory structure captured by an optical sensor, deployed in a store, at a first time in Block S120; identifying a first cluster of regions, in the first image, depicting a first set of slots assigned to product types supplied by the first supplier in Block S130; identifying a second cluster of regions, in the first image, depicting a second set of slots assigned to product types supplied by a second set of suppliers excluding the first supplier in Block S132; obfuscating the second cluster of regions in the first image to generate a masked image in Block S134; detecting a first set of features in the first cluster of regions in the first image in Block S140; interpreting a first set of stock conditions of the first set of slots at the first time based on the first set of features in Block S142; and, based on the query, serving the masked image to the first supplier in Block S150 and serving the first set of stock conditions of the first set of slots to the first supplier in Block S160.

One variation of the method S100 includes: accessing a first image of an inventory structure captured by an optical sensor, deployed in a store, at a first time in Block S112; detecting a group of slots, in the inventory structure, depicted in the first image in Block S122; identifying a first set of product types assigned to the group of slots in Block S124; detecting a set of features in regions of the first image corresponding to the group of slots in Block S140; detecting a first set of stock conditions of the first set of product types occupying the group of slots at the first time based on the set of features in Block S142; accessing a query from a first supplier to the store in Block Silo; identifying a first cluster of regions, in the first image, depicting a first set of slots assigned to product types supplied by the first supplier in Block S130; identifying a second cluster of regions, in the first image, depicting a second set of slots assigned to product types supplied by a second set of suppliers excluding the first supplier in Block S132; obfuscating the second cluster of regions in the first image to generate a masked image in Block S134; and, based on the query, serving the masked image to the supplier in Block S150 and serving the first set of stock conditions of the first set of slots to the supplier in Block S160.

### 2. Applications

Generally, the method S100 shown in FIG. 1 can be executed by a computer system: to access an image—of an inventory structure—captured by a camera unit (e.g., a fixed camera, a mobile robotic system) deployed within a store; detect slots on the inventory structures in the image; detect and identify product types of product units occupying these slots based on features detected in the image; and derive stock conditions of these slots based on presence and locations of these product units. The computer system can further: identify a subset of slots—depicted in the image—assigned to product units supplied by a particular supplier (e.g., a manufacturer, a distributor), such as by querying a planogram of the store or a supplier-product type database; mask (e.g., redact, blur, overlay with stock product images) regions of the image depicting slots not assigned to or containing product types supplied by the supplier; aggregate stock conditions of slots assigned to or containing product types supplied by the supplier; and serve the masked image and stock conditions to the supplier.

The computer system can therefore enable the supplier to view stock conditions, locations, and distribution of product types—supplied by the supplier—in the store without physically entering the store. More specifically, by masking an image of an inventory structure to depict only product types supplied by the supplier, the computer system can: enable the supplier (e.g., a representative of a distributor, manufacturer, or other product supplier) to visually monitor distribution of its products in the store and to access visual context of stock conditions of these products in the store; and prevent the supplier from accessing image and stock conditions of competing products stocked in the same store.

Therefore, the computer system can: interface with a camera unit or set of camera units installed in a store to access a set of images of the set of products, slots, shelves, or shelving structures in the store; extract data, statistics and metrics from the set of images; merge data from this set of images to monitor the stock state of the store over time; and selectively serve masked images and stock conditions of product types—supplied by a particular supplier—to the supplier via a supplier portal.

The computer system can serve images and relative metrics of products stocked on shelves of stores to a supplier based on: subscription status; and affiliation of the supplier to a product (e.g., supplier of a product or competing product, supplier of product in same product category). The computer system can then automatically: track stock-related events across a population of stores based on images captured by fixed and/or mobile cameras deployed in these stores; match these stock-related events to the access configuration for the supplier; and then generate and serve corresponding notifications—such as in the form of electronic messages containing masked images and/or product metrics—to the supplier based on matched events.

Furthermore, the computer system can: selectively serve images—via a supplier portal and subject to restrictions based on a supplier profile and associated permission set—to a supplier. The permission set contains: an inclusion list defining a list of product types for which the supplier is permitted to view images and access metrics; and an exclusion list defining a list of product types for which the supplier is not permitted to view images or access metrics. Before serving such data to a supplier, the computer system can access the exclusion list; scan images of shelves in a store for products enumerated on the exclusion list; redact or obfuscate regions of these images depicting excluded product types; compile metrics for products on the supplier's inclusion list; and then present (e.g., render, transmit) these data to the supplier via a supplier portal. More specifically, if a product on the exclusion list is present in an image of a shelf captured during an inventory check in a store, the computer system can redact regions of the image to obscure the product and remove the data pertaining to the product from the metrics derived for the supplier.

Furthermore, the computer system can receive a request from a supplier to add a product to exclusion lists for other suppliers and update corresponding permission sets accordingly. For example, when a first supplier releases a new product and desires performance data for the new product with limited remote access to the new product and related data by competitors, the first supplier may enter a request, via the supplier portal, to add the new product to exclusion lists for other suppliers, such as for a limited period of time (e.g., four weeks). Subsequently when a second supplier (e.g., a competitor) requests images and metrics that depict the new product, the computer system can: selectively redact these images and data based on the second supplier's updated exclusion list; and serve the image to the second supplier with the new product obscured.

### 3. System

In one implementation shown in FIG. 1, a camera unit includes a fixed color camera mounted in a fixed location facing an inventory structure within a store. Generally, the camera unit is mounted facing an inventory structure containing a slot, the slot containing a product stocked in the store. The camera unit can include: a housing, an optical sensor, a motion sensor, a processor, a communications module, and a power supply. In one implementation, the optical sensor is capable of capturing 2D or 3D images and defines a field of view. The motion sensor can include a passive infrared sensor capable of outputting a signal representing motion within or near the field of view of the optical sensor (i.e., the field of view of the motion sensor covers at least the area of the field of view of the optical sensor). The communications module can transmit data, including images, from the camera unit to the computer system in real time or asynchronously, via a wired or wireless connection. The power supply can be internal (i.e., a battery), or external (i.e., a wired connection or inductive power transfer system.)

In particular, the camera unit can be arranged in a fixed position and can capture images—via the optical sensor—of a segment of an inventory structure at a fixed distance and a fixed angle such that the field of view of the camera unit remains constant and the segment of an inventory structure remains in focus. Therefore, images captured by the camera unit may repeatably depict the same segment of an inventory structure and therefore the same constellation of slots within the inventory structures. The computer system can therefore compare consecutive images to detect changes in organization and stock condition of these slots.

A computer system interfaces with the camera unit to aggregate data, particularly images, received from the camera unit (and/or other camera units) and analyze images to extract data, metrics, and statistics. The computer system can be a local computer (i.e., located within the store) or a computer system (i.e., a server or set of servers). The computer system can compile and analyze images captured by the camera unit for patterns, characteristics, or events. The computer system can compile metadata (data about the image) and write this metadata to a file associated with the image and upload the image and associated metadata file to a searchable database. The computer system can later retrieve the image by searching the database, specifically searching the metadata files, to find and retrieve the image.

### 4. Hierarchy and Terms

A “store” is referred to herein as a (static or mobile) facility containing one or more inventory structures.

A “product type” is referred to herein as a type of loose or packaged good associated with a particular product identifier (e.g., a SKU) and representing a particular class, type, and varietal. A “unit” or “product unit” is referred to herein as an instance of a product type—such as one bottle of detergent, one box of cereal, or package of bottled water—associated with one SKU value.

A “product facing” is referred to herein as a side of a product designated for a slot.

A “slot” is referred to herein as a section (or a “bin”) of a shelf on an “inventory structure” designated for storing and displaying product units of the product type (i.e., of the same SKU or CPU). An inventory structure can include a shelving segment, a shelving structure, or other product display containing one or more slots on one or more shelves.

A “planogram” is referred to herein as a plan or layout designating display and stocking of multiple product facings across multiple slots, such as: in a particular shelving segment; across a particular shelving structure; across multiple shelving structures within a particular aisle; across multiple aisles in the store; or throughout the entirety of the store. For example, the planogram can define a graphical representation of an inventory structure in the store, including graphical representations of each slot in this inventory structure, each populated with a quantity of graphical representations of product type assigned to this slot equal to a quantity of product facings assigned to this slot. Alternatively, the planogram can record textual product placement for one or more inventory structures in the store in the form of a spreadsheet, slot index, or other database.

Furthermore, a “realogram” is referred to herein as a representation of the actual products, actual product placement, actual product quantity, and actual product orientation of products and product units throughout the store during a scan cycle, such as derived by the computer system according to Blocks of the method S100 based on photographic images and/or other data recorded by the camera unit in the store.

### 5. Image Acquisition

Block S120 of the method S100 recites accessing a first image of an inventory structure captured by an optical sensor, deployed in a store, at a first time.

Generally, the camera unit can capture an image (e.g., a color photographic image) of a segment of an inventory structure, such as: on a fixed interval (e.g., once per ten minutes); in response to absence of motion in the field of view of the camera unit following a period of motion in the field of view of the camera unit; and/or at predefined times (e.g., after scheduled restocking periods in the store). The camera unit can upload an image to the computer system, such as in real-time or during scheduled upload periods.

Upon receipt of an image in Block S120, the computer system can cache or store the image for immediate or delayed processing to: detect slots—associated with particular suppliers—in the image; characterize stock conditions of these slots; selectively mask (or “redact”) regions of the image depicting slots based on a query received from a supplier (e.g., a distributor, a manufacturer) of a product type assigned to other slots depicted in the image; and distribute this masked image to the supplier responsive to the query.

In one implementation, the camera unit captures images at a fixed image capture interval, such as once per 10-minute interval. The camera unit then detects motion via the motion sensor and the camera unit changes the image capture interval, (e.g., to one image every minute). The camera unit can maintain the higher image capture interval for a set duration or while continuing to detect motion via the motion sensor. After expiration of the duration of time or when the camera unit no longer detects motion in its field of view (e.g., via the motion sensor), the camera unit returns to capturing images on the fixed image capture interval.

In another implementation, the camera unit is in an inactive state, and the optical sensor does not capture images. When the camera unit detects motion via the motion sensor, the camera unit transitions from the inactive state to an active state and begins capturing images via the optical sensor at an interval. After a duration of time, if no further motion is detected by the motion sensor, the camera unit transitions to the inactive state and the optical sensor ceases to capture images. Similarly, in another implementation, the state of the camera unit can be triggered by the computer system in response to a command by an operator of the computer system, or autonomously based on events identified by the computer system. Generally, the camera unit can stream images to the computer system. In one implementation, the camera unit can store images locally and download them later to the computer system either wirelessly or through a wired data connection.

The computer system can then access a latest image captured by the camera unit in Block S120.

### 5.1 Image Compilation

In one variation, a set of camera units with overlapping fields of view are arranged in the store facing a length of (e.g., all shelving segments in) the inventory structures. In this variation, the camera units can be synchronized and configured to capture sets of concurrent images. Accordingly, in Block S120, the computer system can: access a set of concurrent images captured by these camera units; and compile this set of images into a composite image depicting this length (e.g., all of the shelving segments) of the inventory structure. The computer system can then process this composite image, as described below.

### 5.2 Mobile Robotic System

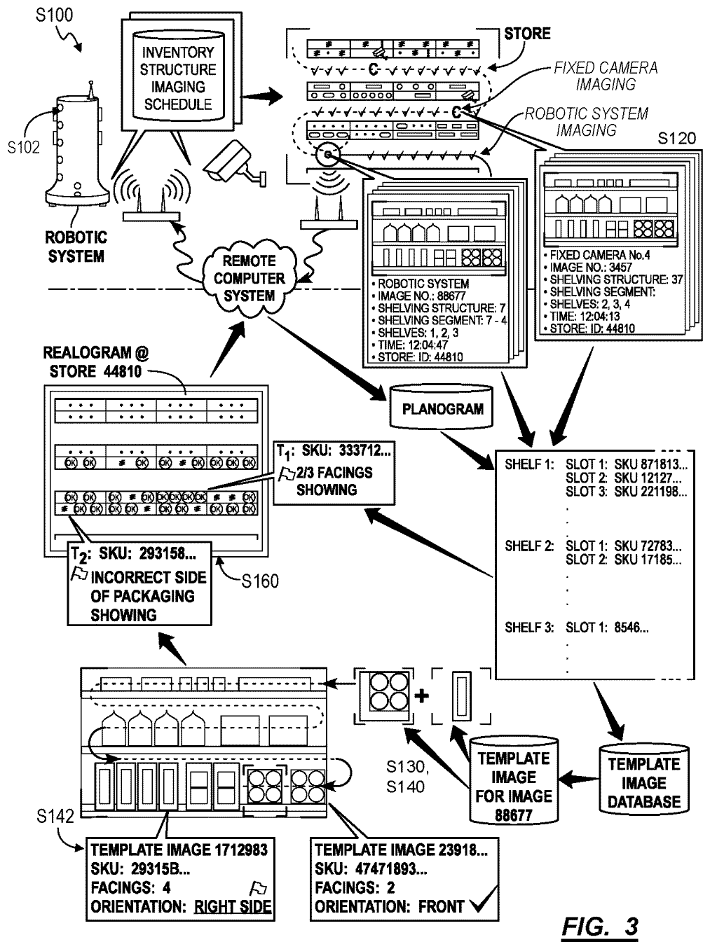

One variation of the method S100 shown in FIG. 3 includes: deploying a robotic system—including an optical sensor—to autonomously navigate throughout the store during a scan cycle in Block S102; and accessing an image captured by the robotic system while traversing an aisle facing the inventory structure in Block S120. In particular, in this variation, the computer system can implement methods and techniques described in U.S. patent application Ser. No. 15/600,527 to deploy a mobile robotic system to autonomously navigate throughout the store during a scan cycle, to capture images of inventory structures throughout the store during the scan cycle, and to offload these images to the computer system. The computer system can then access and process these images as described below.

The computer system can also implement methods and techniques described above to: access a sequence of photographic images captured by the robotic system during the scan cycle while traversing an aisle facing the inventory structure; and compile this sequence of photographic images into the first image defining a composite photographic image depicting a set of shelving segments spanning the first inventory structure.

However, the computer system can implement any other methods or techniques to access images captured by a fixed camera unit and/or mobile robotic system deployed in the store.

### 6. Image Processing

The method S100 includes: identifying a first cluster of regions, in the first image, depicting a first set of slots assigned to product types supplied by the first supplier in Block S130; identifying a second cluster of regions, in the first image, depicting a second set of slots assigned to product types supplied by a second set of suppliers excluding the first supplier in Block S132; detecting a first set of features in the first cluster of regions in the first image in Block S140; and interpreting a first set of stock conditions of the first set of slots at the first time based on the first set of features in Block S142. Generally, in Blocks S130, S132, S140, and S142, the computer system can: detect and disambiguate regions of the image depicting slots assigned to different product types associated with different suppliers (e.g., different distributors or manufacturers); and derive stock conditions of these slots, such as whether a slot of fully-stocked, understocked, or out of stock and a degree of organization of the slot.

In particular, upon receipt of an image from the camera unit, the computer system: stores the image in a database for later masking and distribution to suppliers associated with product types assigned to slots depicted in the image; implements computer vision techniques to detect slots, detect product units, identify product types of these product units, detect shelf tags, and/or characterize stock conditions in these slots; and associates these slots, product units, shelf tags, and stock condition data with individual suppliers associated with slots depicted in the image.

In one implementation, because the camera unit is fixed, the computer system can match the location of the camera unit to the planogram of the store and map a slot depicted in an image captured by the camera unit to a slot in the planogram. The computer system can: access an image captured by a camera unit in the store; access a location of the camera unit; add a location tag to the image captured by the camera unit; access a planogram of the store containing the location data of a set of slots and the product type assigned to each slot; search the planogram of the store and match the location tag of the image to slot locations in the planogram to define a set of slots depicted in the image; access a database of optical features representing product types assigned to these slots; match optical features depicted in the image to optical features associated with unique product types in the database to identify a product type located in each slot depicted in the image; and generate a realogram representing locations and stock conditions of each slot on the inventory structure depicting in the image.

In another implementation, the computer system: accesses an image captured by the camera unit in the store; retrieves a predefined map of slot locations in the field of view of the camera; segments the image according to the predefined map; and implements the foregoing methods and techniques to identify product unis in each slot based on features extracted from each image segment. In yet another implementation, the computer system accesses an image captured by the camera unit in the store; detects shelf tags on shelves depicted in the image; segments the image by individual shelf slots based on positions of shelf tags depicted in the image; and implements the foregoing methods and techniques to identify product units in each slot based on features extracted from each image segment.

However, the computer system can implement any other method or technique to transform images captured by the camera into stock conditions of slots in the field of view of the camera over time.

### 6.1 Slot Definition+Slot Condition: Shelf Tags

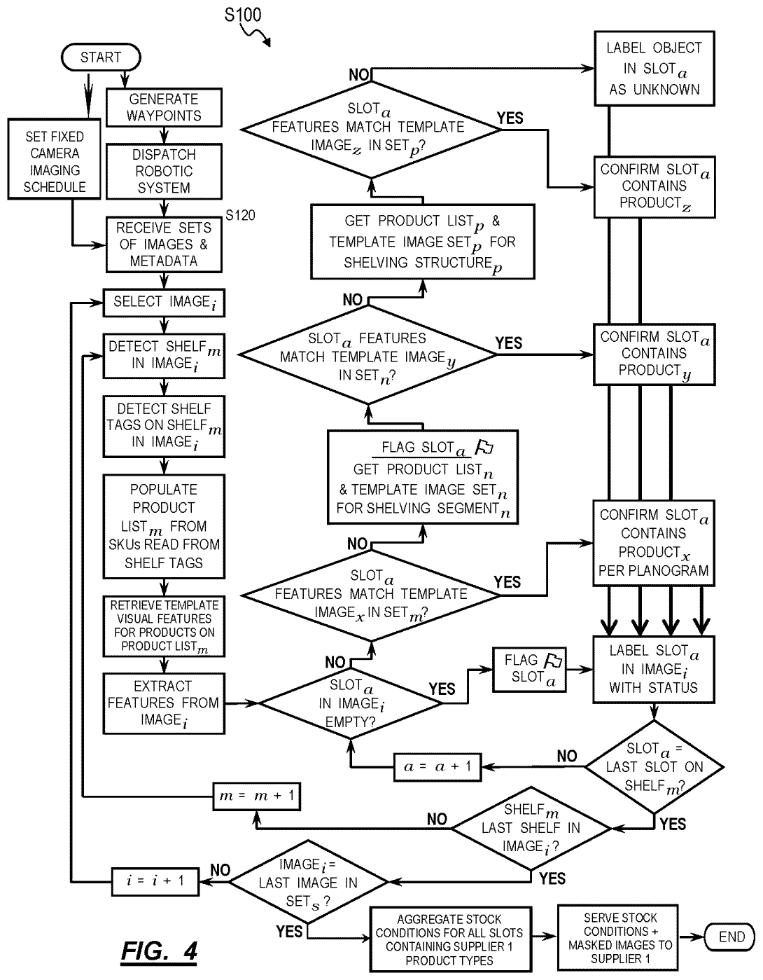

In one implementation shown in FIG. 4, the computer system: isolates regions of the image depicting individual slots on the inventory structure; detects and extracts features from these regions of the image depicting individual slots; and identifies product types of product units occupying these slots based on these features. The computer system can further: characterize organization of individual slots based on orientation of product units and proximity of product units to centers and/or boundaries of corresponding slots; and derive a stock conditions of each slot depicting in the image based on quantities of product types and organization of product units occupying these slots.

In this implementation, the computer system can: detect shelf tags in the image; and define slot boundaries of slots depicted in the image based on positions of these shelf tags. In particular, in this implementation, the computer system can: detect shelf faces in the image; and detect a set of shelf tags on these shelf faces, such as by implementing object re-recognition or template matching techniques, by implementing optical character recognition to detect pricing information on shelf tags, or by detecting optical barcodes on these shelf tags. The computer system can then calculate a rectangular slot boundary of a first slot depicting the image based on locations of shelf tags and shelf faces detected in the image, such as by: locating a bottom edge of a first slot boundary along the top edge of a first shelf face on which the first shelf tag is applied; locating a top edge of the first slot boundary along the bottom edge of a next second shelf face above the first shelf tag; locating a left edge of the first slot boundary in-line with a left edge of the first shelf tag; and locating a right edge of the first slot boundary in-line with a left edge of a second shelf tag to the right of the first shelf tag. The computer system can also: annotate the image with the first slot boundary of the first slot, such as by projecting the first slot boundary onto the image; extract an identifier (e.g., a SKU value, a barcode) of a first product type specified by the first shelf tag and thus assigned to the first slot; and annotate the first slot boundary with the identifier of the first product type. Alternatively, the computer system can: identify a first slot address of the first slot, such as based on a position of the first slot in the inventory structures or based on slot address extracted (e.g., read) from the first shelf tag; query a planogram of the store for the identifier of the first product type assigned to the first slot based on the first slot address; and annotate the first slot boundary with the identifier of the first product type. The computer system can repeat this process for each other shelf tag detected in the image.

In this implementation, the computer system can then: detect a first product unit, of a first product type assigned to the first slot, in a first region of the image depicting the first slot and contained within a first slot boundary of the first slot; and derive a first organization metric of the first slot based on a position of the first product unit relative to the first slot boundary. For example, the computer system can: retrieve a first set of template features (e.g., product packaging text, product packaging geometry, product packaging colors or color histogram, product packaging template images) representing the first product type assigned to the first slot; detect a first object in the first region of the image bounded by the first slot boundary; extract a first set of image features from a first subregion of the image representing the first object; calculate a first similarity score between the first set of template features and the first set of image features; and identify the object as a first product unit of the first product type if the first similarity score exceeds a threshold score. The computer system can implement similar methods and techniques to detect product units of other product types—not assigned to the first slot—present in the first slot.

The computer system can repeat this process for each other object detected in the first slot to generate a count of product units of the first product type (and other product types) occupying the first slot. The computer system can also characterize organization of the first slot based on arrangement and orientation of product units detected in the first slot. The computer system can store this count of product units and their organization in the first slot as a first stock condition of the first slot.

The computer system can then repeat this process to derive a stock condition of each other slot depicted in the image.

### 6.2 Slot Definition+Slot Condition: Known Sensor Field of View

In another implementation, the computer system projects a stored slot boundary onto the image to define slot boundaries of slots depicted in the image. For example, for an image capture by a fixed camera facing a static inventory structure, the computer system can: retrieve a stored slot boundary template defining slot boundaries of slots in the field of view of the fixed camera; and project the stored slot boundary template onto the image to define slot boundaries of these slots on the image. The computer system can then execute the foregoing methods and techniques to derive a stock condition of each slot depicted in the image.

In a similar implementation, the computer system can: access a photographic image captured by a fixed camera at a first time; retrieve a geometry of a field of view of the fixed camera based on a known location of the fixed camera within the store; project the geometry of the field of view onto a planogram of the store; and thus identify a group of slots—within the inventory structure—depicted in the photographic image based a distribution of slots within the planogram contained within this field of view projection.

Alternatively, the computer system can: retrieve a stored geometry of slots in a known field of view of the fixed camera, such as stored in the planogram of the store or otherwise associated with the fixed camera; and identify a group of slots—within the inventory structure—depicted in the photographic image based on a projection of the stored geometry of slots onto the photographic image.

As described above, the computer system can then: extract a first constellation of features from a first region of the photographic image corresponding to a first slot in the first set of slots; retrieve a first product model representing a first set of visual characteristics of a first product type assigned to the first slot by the planogram; detect presence of a first product unit of the first product type occupying the first slot in the inventory structure at the first time in response to the first constellation of features approximating the first set of visual characteristics represented in the first product model; and repeat this process to detect and identify product types of other product units occupying the inventory structure and depicted in the photographic image.

### 6.3 Slot Definition+Slot Condition: Product Clusters

In yet another implementation, the computer system can: implement the foregoing methods and techniques to detect clusters of product units of the same product type in the image; and define slot boundaries of slots depicted in the image around clusters of product units of the same product type. The computer system can then execute the forgoing methods and techniques to derive a stock condition of each slot depicted in the image.

However, the computer system can implement any other method or technique to derive a stock condition of each slot depicted in the image.

### 6.4 Stock Flow

In one implementation, the computer system repeats the foregoing methods and techniques to process a sequence of images captured by the camera unit over time and compiles stock conditions of individual slots—over a time period represented by the sequence of images—into “stock flows” of known product types from these slots, such as: fully-stocked rate or duration; understocked rate or duration; out-of-stock rate or duration; product unit sale rate; and/or product unit organization change over time for individual slots.

Therefore, the computer system can: derive a stock flow of a set of product types—supplied by the supplier and assigned to a first set of slots in an inventory structure—between a first time and a second time based on: a first set of stock conditions in the set of slots derived from a first image of the inventory structure captured at the first time; and a second set of stock conditions in the set of slots derived from a second image of the inventory structure captured at the second time. The computer system can then serve the stock flow of the set of product types to the supplier, such as responsive to a query.

For example, based on a query for product flow of product types, associated with a supplier, between restocking periods within the store, the computer system can: select a first image captured at a first time succeeding a first scheduled restocking period in the store and depicting slots assigned to product types associated with the supplier; select a second image captured at a second time preceding a second (i.e., next) scheduled restocking period in the store and depicting the same constellation of slots; derive stock flows of a set of product types—associated with the supplier and assigned to slots depicted in the first and second images—between the first scheduled restocking period and the second scheduled restocking period based on differences in product unit count and position depicted in these images; and then serve these stock flows to the supplier.

In a similar example, the computer system can automatically interpret recent and subsequent restocking of slots depicted in images captured by the camera unit based on increases in quantities of product units in these slots between subsequent images. In particular, the computer system can: derive a first set of stock conditions from a first image captured by the camera unit at a first time; detect a high frequency of understock and/or out-of-stock conditions in a set of slots depicted in the first image; derive a second set of stock conditions from a second image captured by the camera unit at a second time succeeding the first time; detect a high frequency of understock and/or out-of-stock conditions in the set of slots depicted in the second image; and thus select the second image as depicting a first post-restocking state of the inventory structure. Later, the computer system can: derive a third set of stock conditions from a third image captured by the camera unit at a third time succeeding the second time; detect a high frequency of understock and/or out-of-stock conditions in the set of slots depicted in the third image; derive a fourth set of stock conditions from a fourth image captured by the camera unit at a fourth time succeeding the third time; detect a low frequency of understock and/or out-of-stock conditions in the set of slots depicted in the fourth image; and thus select the third image as depicting a second pre-restocking state of the inventory structure. Accordingly, the computer system can: derive a time duration between restocking of the inventory structure based on a time difference between the second image and the third image; derive stock flows of slots in the inventory structure based on a difference in stock conditions depicted in the second and third images; and serving the time duration between restocking of the inventory structure and stock flow of slots—assigned to product types associated with a particular supplier—to the particular supplier responsive to a query from the particular supplier.

### 7. Supplier Profile

In one implementation shown in FIG. 1, the computer system interfaces with a supplier via a supplier portal, such as an application running on a local computer system, a web-based portal, a distributed network (i.e., cloud), etc. The computer system generates a supplier profile for each supplier including supplier identity, permission set, and supplier preferences. The supplier identity includes identifying information about the supplier including supplier name, password, and company name. The computer system populates a permission set with data (e.g., images, product and shelf metrics) that a particular supplier is permitted to view, such as in the form of: a list of product types; a set of store locations; a set of times during which data is collected; or data access latency (e.g., a minimum time from data capture within a store to access of these data by the supplier).

The supplier identity defines a set of attributes that identify an individual supplier and can include a unique supplier identifier such as a supplier number, supplier name and password, and/or company name. The supplier identity can also include attributes that define characteristics of the supplier, such as supplier type (e.g., store relationship; consumer packaged goods company, distributor of many product types, single product vendor, direct store delivery vendor) and category of product types manufactured or supplied (e.g., fresh produce, canned goods, soft drinks) by the supplier. For example, the supplier may be other than a store employee or member of the store's supply chain staff.

The permission set defines characteristics of images or product types that the supplier is permitted to view. The computer system can configure the permission set based on the supplier identity, subscription status, and store location. The permission set can include an inclusion list of product types defining a set of product types that the supplier is permitted to view. For example, the computer system can populate the inclusion list with: a list of product types supplied to a particular store by the supplier; a list of product types supplied to any store by the supplier; a list of product categories of product types supplied to the store by the supplier; and/or a list of product types supplied to particular competitors to the supplier; and/or store locations. The computer system can thus implement Blocks of the method S100: to process images captured in stores on the supplier's inclusion list; to mask these images to only depict product units of product types on the supplier's inclusion list; (or to mask these images to only depict slots assigned to product types on the supplier's inclusion list); and to serve these masked images to the supplier.

### 8. Query

Block S110 of the method S100 recites accessing a query from a first supplier to the store. Generally, in Block S110, the computer system can: receive a manually-entered one-time request to view a region of an inventory structure assigned to product types supplied by a supplier; access a stored, recurring query (e.g., a daily or weekly subscription) for an image of an inventory structure assigned to product types supplied by the supplier; and/or derive a query based on a predefined trigger set by the supplier and a stock condition recently detected in the store.

For example, the computer system can: receive a query to remotely view images and access stock conditions of product types manufactured (or distributed) by the supplier and supplied to the store, such as at a particular time or on a particular date; and retrieve images captured by camera units in the store around the particular time or on the particular date. The computer system can then implement methods and techniques described herein to: detect slots in these images; identify product types assigned to these slots; isolate a subset of these slots assigned product types supplied by the supplier or that otherwise fulfill the supplier's permission set; derive slot metrics for stock conditions (e.g., fully-stocked, understocked, out-of-stock, organized, disorganized, out-of-stock duration) in this subset of slots; redact these images to generate masked images that only depict the subset of slots assigned product types supplied by the supplier; and then serve these images and the corresponding slot metrics to the supplier.

In one implementation, the computer system: hosts a supplier portal, such as accessible through a web browser or native application; receives a query to remotely view stock conditions—of product types manufactured (and/or distributed) by a supplier in the store; and then executes methods and techniques described herein to mask an image depicting slots assigned to these product types and to return this masked image to the supplier via the supplier portal.

In another implementation, the computer system: generates and stores a supplier profile for the supplier; and interfaces with a representative of the supplier to populate the supplier profile with subscription image feeds of slots throughout the store. For example, the computer system can generate and store daily or weekly subscriptions to images of constellations of slots—assigned to product types and/or to product categories supplied by the supplier—in the supplier profile. The computer system then: automatically generates queries (or commands, prompts) for distribution of images to the supplier according to these subscriptions; and implement methods and techniques described herein to selectively serve masked images and related slot metrics to the supplier according to these subscriptions. Therefore, in this implementation, the computer system can push masked images and/or slot metrics to the supplier on a scheduled interval.

Additionally or alternatively, the computer system can interface with the representative of the supplier to populate the supplier profile with triggers for serving images—of slots assigned to product types and/or to product categories supplied by the supplier—to the supplier, such as: images captured immediately prior to and/or after scheduled restocking periods in the store; images captured immediately prior to and/or after detected slot restocking (e.g., as detected automatically by the computer system based on reduction in out-of-stock slots detected from one image to a next image of an inventory structure); images of inventory structures containing more than a threshold frequency of out-of-stock slots assigned to product types supplied by the supplier; images of inventory structures containing slots assigned to product types supplied by the supplier and associated with out-of-stock statuses for more than a threshold time duration; or images of inventory structures containing slots assigned to product types supplied by the supplier and associated with durations of time from fully-stocked to out-of-stock less than a threshold time duration; etc. The computer system can then implement methods and techniques described herein to: automatically detect trigger events that fulfill these triggers based on stock conditions derived from images captured by camera units deployed in the store; generate queries responsive to these trigger events; and selectively serve masked images and related slot metrics to the supplier accordingly. Therefore, in this implementation, the computer system can push masked images and/or slot metrics to the supplier responsive to prescribed trigger events detected in the store.

### 9. Image Masking

In Block S134, the computer system selectively masks (e.g., blurs, redactors, overlays stock product imagery) an image to obfuscate stock conditions of slots based on a supplier's permission set.

The method S100 is described below as executed by the computer system to selectively mask images to obscure product units of product types not supplied by the supplier and/or to obscure slots assigned to product types not supplied by the supplier. However, the computer system can selectively mask images according to any other permissions defined in the supplier's permission set.

In one implementation shown in FIG. 1, the computer system can: implement methods and techniques described above to identify individual slots depicted in the image; identify product types assigned to these slots based on product type data read from corresponding shelf tags, retrieved from the planogram of the store, or interpreted from product types of product units detected in these slots; and query a supplier database or product type database to identify suppliers (e.g., manufacturers, distributors) that supply these product types to the store. Based on a query from a particular supplier, the computer system can aggregate images that depict slots assigned to product types supplied by the particular supplier and that fulfill terms of the query (e.g., image capture date, product category). Then, for each image in this set of images, the computer system can: identify a first set of slots assigned to product types supplied by the particular supplier in Block S130; identify a second set of slots assigned to product types supplied by any supplier other than the particular supplier in Block S132; redact, blur, or overlay stock imagery over each slot in the second set of slots to generate a masked image in Block S134; and serve this masked image to the particular supplier, thereby enabling the particular supplier to view stock conditions of slots assigned to product types supplied by the particular supplier with reduced, limited, or no remote visual access to stock conditions of slots assigned to product types supplied by other suppliers.

In one example, after receiving a query associated with a first supplier and processing an image as described above to detect slots in the inventory structure depicted in the image, the computer system: identifies a first set of product units—supplied by the first supplier—in a first region of the image based on features detected in the image; identifies a particular product unit—supplied by a second supplier distinct from the first supplier—in a particular region of the image based on features detected in the image; obfuscates (e.g., redacts, blurs) the particular region of the image when generating a masked image, thereby hiding the particular product unit in the masked image; and then serves the masked image—depicting the first set of product units in the first cluster of regions and obfuscated over the particular product unit—to the first supplier.

Conversely, responsive to receiving a query from a second supplier for visual data of other slots depicted in the same image, the computer system can: identify a second cluster of regions in the image depicting a second set of slots assigned to product types supplied by the second supplier; obfuscate a first set of regions in the image—depicting the first set of product units supplied by the first supplier—to generate a second masked image; detect a second set of features in the second cluster of regions in the image; interpret a second set of stock conditions of the second set of slots based on the features detected in the image; and serve the second masked image and the second set of stock conditions of the second set of slots to the second supplier.

### 9.1 Image Mask: Predefined Image Mask

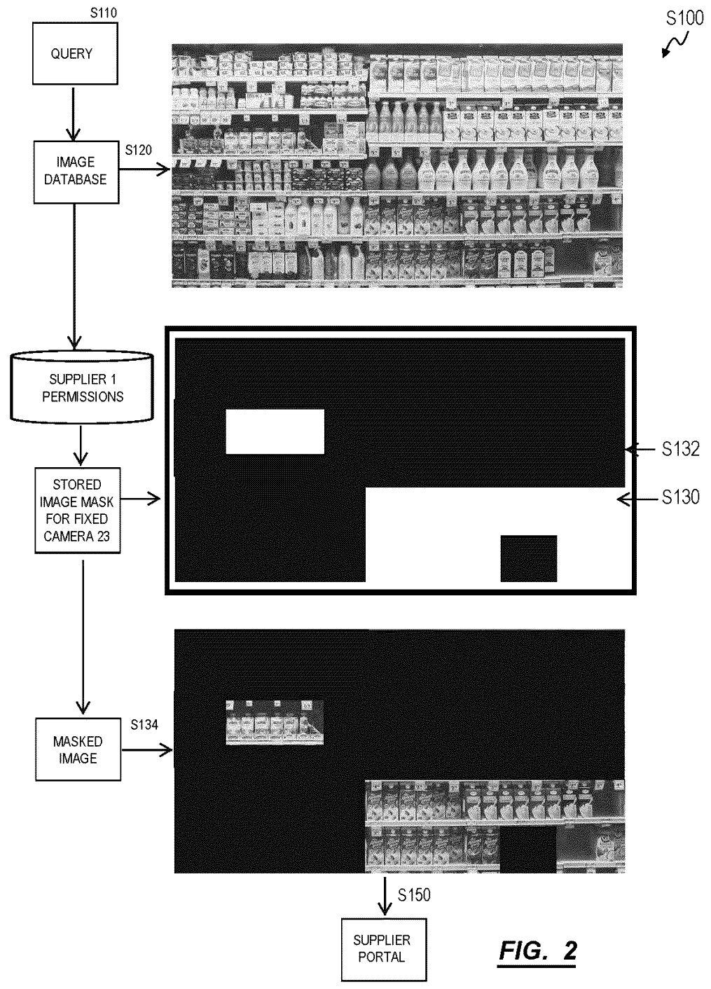

In one variation shown in FIG. 2, the computer system can: access a predefined image mask—associated with the first supplier and the inventory structure and/or the camera unit—configured to pass regions of images of the inventory structure that depict slots assigned to product types supplied by the first supplier and to mask (e.g., blur, redact) all other slots depicted in these images; and project this mask onto images of the inventory structure prior to serving these images to the first supplier.

In one implementation, the computer system can access: a photographic image of the inventory structure image captured by a fixed camera, arranged within the store, at the first time; and a predefined image mask associated with the first supplier and the fixed camera, transparent to regions of images—captured by the fixed camera—that align to slots assigned to product types supplied by the first supplier, and opaque to the regions of these images depicting slots assigned to product types not supplied by the first supplier. The computer system can then apply the predefined image mask to the photographic image to generate the masked image prior to serving the masked image to the first supplier.

### 9.2 Selective Image Masking by Product Category

In another variation shown in FIG. 1, the computer system selectively masks (e.g., blurs, redacts) regions of images depicting product types in product categories not supplied by the supplier, thereby enabling the supplier to view stock conditions of product types not supplied by the supplier, but associated with the same product category as product types supplied by the supplier.

In one implementation, after receiving a query associated with a first supplier and processing an image as described above to detect slots in the inventory structure depicted in the image, the computer system: retrieves a first product category associated with the first supplier; identifies a third set of products types in the first product category and supplied by a third set of manufacturers distinct from the first supplier; and identifies a third cluster of regions, in the image, depicting a third set of slots assigned to product types in the third set of product types. Accordingly, the computer system can generate a masked image: that depicts a first set of slots assigned to product types supplied by the first supplier; that depicts a third set of slots assigned to product types not supplied by the first supplier but associated with the same product category of product types supplied by the first supplier; and that is obfuscated (e.g., blurred, redacted) over slots assigned to product types not supplied by the first supplier and not associated with the same product category of product types supplied by the first supplier.

In this implementation, the computer system can also: detect a set of shelf tags—corresponding to the third set of slots—in the image; and obfuscate the third set of shelf tags in the masked image, thereby limiting remote visual access to competitor product data.

### 9.3 Masked Image Augmentation

In one variation shown in FIG. 1, the computer system overlays stock imagery (e.g., stored reference images or renderings of product types) on regions of image depicting slots assigned to product types not supplied by the first supplier, thereby enabling the first supplier to view placement of its product types relative to other product types in the store without visually accessing real stock condition data of these other product types.

In one implementation, after receiving a query associated with a first supplier and processing an image as described above to detect slots in the inventory structure depicted in the image, the computer system: aggregates a list of product types depicted in the image but not supplied by the first supplier; retrieves a set of stock product images of product types in this list; and overlays this set of stock product images over regions of the image depicting these product types when generating the masked image.

In a similar implementation, the computer system: aggregates a list of product types assigned to slots depicted in the image but not supplied by the first supplier; retrieves a set of stock product images of product types in this list; and overlays this set of stock product images over regions of the image depicting these slots when generating the masked image.

### 9.4 Linked Stock Conditions and Masked Images

In one variation shown in FIG. 1, the computer system: implements methods and techniques described above to derive stock conditions of slots assigned to product types supplied by the first supplier; compiles these stock conditions into a table or report that identifies locations, recent stock conditions, stock flow, and/or timeseries stock conditions of these product types; links each product type to a recent image depicting an inventory structure containing a slot assigned to the product type; and serves this table or report to the first supplier. Thus, upon viewing the table or report, the first supplier may access visual data (e.g., images) depicting its product types in the store by selecting these links in the table or report.

For example, the computer system can: access images of many inventory structures arranged throughout the store (and thus imaged by many different fixed cameras or by a mobile robotic system deployed in the store); implement methods and techniques described above to derive stock conditions of slots in these inventory structures; compile stock conditions of product types—supplied to the store by the first supplier—into a table identifying locations and stock condition of these product types; and serve the table to the first supplier. The computer system can then serve a masked image of a particular inventory structure containing a slot assigned to a particular product type supplied by the first supplier in response to selection of the particular product type from the table (e.g., the “query”).

### 10. Operation

In one variation, upon receiving a request from a supplier—via the supplier portal (e.g., executing on the supplier's smartphone or desktop computer)—to view an image depicting product units in the store, the computer system: accesses a permission set associated with the supplier's profile; retrieves a set of images—stored in an image database—that match the supplier's request (e.g., depict product types or slots assigned to product types requested by the supplier) and fulfill the supplier's permission set (e.g., were recorded within a time period that the supplier is permitted to access); selectively masks these images to obscure particular product units and/or slots assigned to particular product types based on lack of permission to view these product type in the supplier's profile; and then serves these masked images to the supplier via the supplier portal.

In particular, the computer system can access a set of store locations—designated for data access by the supplier—in the supplier's permission set and access the supplier's inclusion list, such as including: a set of product types supplied to the store by the supplier; a set of product types supplied to the store by a competitor of the supplier; and/or a set of product types in a product category or product sub-category of product types supplied by the supplier. The computer system then isolates a subset of images—from the database—that: were captured in the set of store locations in the supplier's permission set; and are labeled with at least one product type on the supplier's inclusion list. Then, for a first image in this subset, the computer system can: identify a first region of the image depicting a first product unit; redact the first region of the image—such as by blurring or applying a mask over the first region of the image—if the first product unit is of a product type excluded from the supplier's inclusion list; and repeat this process for each other product unit or slot depicted in the image.

The computer system can then repeat this process for each other image in the subset of images and present these masked images to the supplier via the supplier portal, thereby enabling the supplier to remotely view products—that fulfill her permission set—in slots across the store or across a population of stores.

### 11. Temporal Limitations

In one variation, the supplier profile defines a latency limitation for image access by the supplier, such as: a maximum age of image regions depicting slots assigned to product types supplied by the supplier (e.g., one year); and a minimum age of image regions depicting slots assigned to product types not supplied by the supplier (e.g., six months). For example, based on supplier queries, the computer system can: serve data and images for product types supplied by the supplier to the supplier in real-time; serve data and images regarding products not supplied by the supplier, recorded not less than a minimum time duration in the past (e.g., one week), and recorded not more than a maximum time duration in the past (e.g., six months) to the supplier; and/or serve data and images recorded in stores not supplied by the supplier and recorded not less than a minimum time duration in the past (e.g., one day) to the supplier. The computer system can therefore selectively serve these data to the supplier based on temporal limitations defined in the supplier's profile.

For example, the computer system can: access a first image recorded at any time (e.g., on a current date, previous week, previous month, or previous year); mask the first image to depict only slots assigned to product types supplied by a first supplier; serve this first image to the first supplier responsive to a request from the first supplier; and thus implement no temporal limitation for stock data specifically associated with product types supplied by the first supplier when these data are shared with the first supplier. In this example, the computer system can also: access a second image recorded more than a first minimum time duration from the current date (e.g., more than one week or month from the current date); mask the second image to depict both slots assigned to product types in the same product category and supplied by the first supplier and a second supplier; serve this second image to the first supplier responsive to a request from the first supplier; and thus implement a minimum temporal limitation for stock data associated with product types in the same category and supplied by multiple suppliers when these data are shared with the first supplier. Furthermore, In this example, the computer system can: access a third image recorded more than a second minimum time duration from the current date (e.g., more than one quarter or year from the current date); mask the third image to depict both slots assigned to product types not supplied by the first supplier but associated with a product category of product type supplied by the first supplier; serve this third image to the first supplier responsive to a request from the first supplier; and thus implement a longer minimum temporal limitation for stock data associated with product types that may be competitive with the first supplier's product types.

### 12. Exclusion List

In one variation, the computer system maintains an exclusion list of product types and/or stores for which distribution of image data and related metrics to the supplier is restricted. Accordingly, the computer system can: restrict access to images—captured in stores on the supplier's exclusion list—by the supplier; and mask (e.g., redact) regions of images depicting product units of product types on the exclusion list and depicting slots assigned to product types on the exclusion list before serving these images to the supplier.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a supplier computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a query from a first supplier of product to a store;
accessing a first image of an inventory structure captured by an optical sensor, deployed in a store, at a first time;
identifying a first cluster of regions, in the first image, depicting a first set of slots assigned to product types supplied by the first supplier;
identifying a second cluster of regions, in the first image, depicting a second set of slots assigned to product types supplied by a second set of suppliers excluding the first supplier;
obfuscating the second cluster of regions in the first image to generate a masked image;
detecting a first set of features in the first cluster of regions in the first image;
interpreting a first set of stock conditions of the first set of slots at the first time based on the first set of features; and
based on the query:
serving the masked image to the first supplier; and
serving the first set of stock conditions of the first set of slots to the first supplier.

2. The method of claim 1:
wherein accessing the first image comprises accessing the first image comprising a photographic image captured by a fixed camera, arranged within the store, at the first time;
wherein identifying the first cluster of regions, in the first image, depicting the first set of slots comprises:
retrieving a geometry of a field of view of the fixed camera at the first time; and
identifying the group of slots, within the inventory structure, depicted in the photographic image based on a projection of the geometry of the field of view onto a planogram of the store;
wherein detecting the first set of features in the first cluster of regions of the first image comprises extracting a first constellation of features from a first region of the photographic image corresponding to a first slot in the first set of slots; and
wherein interpreting first set of stock conditions of the first set of slots at the first time comprises:
retrieving a first product model representing a first set of visual characteristics of a first product type assigned to the first slot by the planogram; and
detecting presence of a first product unit of the first product type occupying the first slot in the inventory structure at the first time in response to the first constellation of features approximating the first set of visual characteristics represented in the first product model.

3. The method of claim 1, wherein accessing the query from the first supplier comprises receiving the query to remotely view the first set of stock conditions, of product types manufactured by the first supplier, in the store.

4. The method of claim 1:
wherein accessing the first image comprises accessing the first image comprising a photographic image captured by a fixed camera, arranged within the store, at the first time;
wherein identifying the first cluster of regions in the first image and identifying the second cluster of regions in the first image comprises accessing a predefined image mask:
associated with the first supplier and the fixed camera;
transparent to the first cluster of regions; and
opaque to the second cluster of regions; and
wherein obfuscating the second cluster of regions in the first image to generate the masked image comprises applying the predefined image mask to the photographic image to generate the masked image.

5. The method of claim 1, further comprising:
accessing a second image of the inventory structure captured by the optical sensor at a second time;
detecting a second set of features in regions in the first image depicting the first set of slots;
interpreting a second set of stock conditions of the first set of slots at the second time based on the second set of features;
deriving a stock flow of a first set of product types, supplied by the first supplier, between the first time and the second time based on the first set of stock conditions and the second set of stock conditions; and
based on the query, serving the stock flow of the first set of product types to the first supplier.

6. The method of claim 5:
wherein accessing the query comprises accessing the query for product flow between restocking periods within the store;
wherein accessing the first image comprises, based on the query, selecting the first image captured at the first time succeeding a first scheduled restocking period in the store;
wherein accessing the second image comprises, based on the query, selecting the second image captured at the second time preceding a second scheduled restocking period in the store; and
wherein deriving the stock flow of the first set of product types comprises deriving the stock flow of the first set of product types between the first scheduled restocking period and the second scheduled restocking period.

7. The method of claim 5:
wherein accessing the query comprises accessing the query for product flow between restocking periods within the store; and
further comprising:
in response to the first set of stock conditions indicating a low frequency of understock conditions in the first set of slots, selecting the first image as depicting a post-restocking state of the inventory structure;
in response to the second set of stock conditions indicating a high frequency of understock conditions in the first set of slots, selecting the second image as depicting a pre-restocking state of the inventory structure;
deriving a time duration between restocking of the inventory structure based on a time difference between the first image and the second image; and
based on the query, serving the time duration between restocking of the inventory structure to the first supplier.

8. The method of claim 1, further comprising:
detecting a set of shelf tags on the inventory structure in the first image;
calculating slot boundaries of the first set of slots based on locations of corresponding shelf tags in the set of shelf tags; and
annotating the first image with slot boundaries of the first set of slots.

9. The method of claim 8, further comprising, for a first slot in the first set of slots:
detecting a first product unit, of a first product type assigned to the first slot, in a first region of the image depicting the first slot and contained within a first slot boundary of the first slot;
deriving a first organization metric of the first slot based on a position of the first product unit relative to the first slot boundary; and
serving the first organization metric, with the masking image, to the first supplier.

10. The method of claim 1:
further comprising:
retrieving a first product category associated with the first supplier;
identifying a third set of product types:
in the first product category; and
supplied by a third set of manufacturers distinct from the first supplier; and
identifying a third cluster of regions, in the first image, depicting a third set of slots assigned to product types in the third set of product types; and
wherein serving the masked image to the first supplier comprises serving the masked image, depicting the first cluster of regions and the third cluster of regions, to the first supplier.

11. The method of claim 10, further comprising:
detecting a set of shelf tags, corresponding to the third set of slots, in the image; and
obfuscating the set of shelf tags in the masked image.

12. The method of claim 1:
further comprising:
retrieving a first product category associated with the first supplier;
identifying a third set of product types:
in the first product category; and
supplied by a third set of manufacturers distinct from the first supplier; and
identifying a third cluster of regions, in the first image, depicting a third set of slots assigned to the third set of product types;
retrieving a set of stock product images of the third set of product types; and
overlaying the set of stock product images over regions, in the third cluster of regions in the first image, depicting corresponding slots in the third set of slots; and
wherein serving the masked image to the first supplier comprises serving the masked image to the first supplier, the masked image:
depicting the first cluster of regions;
depicting the set of stock images overlayed on the third cluster of regions.

13. The method of claim 1:
wherein identifying the second cluster of regions, in the first image, depicting the second set of slots comprises detecting a particular product unit in a particular region in the first cluster of regions based on the first set of features, the particular product unit supplied by a second supplier distinct from the first supplier;
wherein obfuscating the second cluster of regions in the first image to generate the masked image comprises obfuscating the particular region of the first image to hide the particular product unit in the masked image; and
wherein serving the masked image to the first supplier comprises serving the masked image, depicting the first cluster of regions and obfuscated over the particular product unit, to the first supplier.

14. The method of claim 1:
further comprising deploying a robotic system to autonomously navigate throughout the store during a scan cycle, the robotic system comprising the optical sensor; and
wherein accessing the first image comprises:
accessing a sequence of photographic images captured by the robotic system during the scan cycle while traversing an aisle facing the inventory structure; and
compiling the sequence of photographic images into the first image defining a composite photographic image depicting a set of shelving segments spanning the first inventory structure.

15. The method of claim 1:
further comprising deploying a robotic system to autonomously navigate throughout the store during a scan cycle, the robotic system comprising the optical sensor;
wherein accessing the first image comprises accessing the first image captured by the robotic system while traversing an aisle facing the inventory structure; and
further comprising:
accessing a second image captured by the robotic system during the scan cycle while traversing a second aisle facing a second inventory structure in the store;
identifying a third cluster of regions, in the second image, depicting a third set of slots assigned to product types supplied by the first supplier;
identifying a fourth cluster of regions, in the second image, depicting a fourth set of slots assigned to product types supplied by a third set of suppliers excluding the first supplier;
obfuscating the fourth cluster of regions in the second image to generate a second masked image;
detecting a second set of features in the third cluster of regions in the second image;
interpreting a second set of stock conditions of the third set of slots during the scan cycle based on the second set of features; and
compiling the first set of stock conditions and the second set of stock conditions into a table identifying locations and stock condition of slots in the store, assigned product types supplied by the first supplier, during the scan cycle; and
serving the table to the first supplier; and
wherein receiving the query comprises receiving selection of a particular slot, in the first set of slots, from the table.

16. The method of claim 1:
further comprising accessing a second query from a second supplier to the store, the second supplier distinct from the first supplier;
wherein identifying the second cluster of regions in the first image comprises identifying the second cluster of regions, in the first image, depicting the second set of slots assigned to product types supplied by the second supplier; and
further comprising:
obfuscating the first cluster of regions in the first image to generate a second masked image;
detecting a second set of features in the second cluster of regions in the first image;
interpreting a second set of stock conditions of the second set of slots at the first time based on the second set of features; and
based on the second query:
serving the second masked image to the second supplier; and
serving the second set of stock conditions of the second set of slots to the second supplier.

17. A method comprising:
accessing a query from a first supplier of product to a store;
accessing a first image of an inventory structure captured by an optical sensor, deployed in a store, at a first time;
identifying a first cluster of regions, in the first image, depicting a first set of slots assigned to product types supplied by the first supplier;
identifying a second cluster of regions, in the first image, depicting a second set of slots assigned to product types supplied by a second set of suppliers excluding the first supplier;
obfuscating the second cluster of regions in the first image to generate a masked image; and
based on the query, serving the masked image to the first supplier.

18. The method of claim 17:
further comprising:
detecting a set of shelf tags on the inventory structure in the first image;
calculating a first set of slot boundaries of the first set of slots based on locations of corresponding shelf tags in the set of shelf tags; and
annotating the first image with the first set of slot boundaries; and
wherein identifying the first cluster of regions, in the first image, depicting a first set of slots comprises defining the first cluster of regions bounded by the first set of slot boundaries.

19. A method comprising:
accessing a first image of an inventory structure captured by an optical sensor, deployed in a store, at a first time;
detecting a group of slots, in the inventory structure, depicted in the first image;
identifying a first set of product types assigned to the group of slots;
detecting a set of features in regions of the first image corresponding to the group of slots;
detecting a first set of stock conditions of the first set of product types occupying the group of slots at the first time based on the set of features;
accessing a query from a first supplier of product to the store;
identifying a first cluster of regions, in the first image, depicting a first set of slots assigned to product types supplied by the first supplier;
identifying a second cluster of regions, in the first image, depicting a second set of slots assigned to product types supplied by a second set of suppliers excluding the first supplier;
obfuscating the second cluster of regions in the first image to generate a masked image; and
based on the query:
serving the masked image to the supplier; and
serving the first set of stock conditions of the first set of slots to the supplier.

20. The method of claim 19:
wherein accessing the query from the first supplier comprises receiving the query to remotely view the first set of stock conditions, of product types manufactured by the first supplier, in the store; and
wherein obfuscating the second cluster of regions in the first image comprises blurring the second cluster of regions in the first image to generate the masked image.
